(19) United States
(12) Patent Application Publication
(10) Pub. No.: US 2025/0192633 A1
(43) Pub. Date: Jun. 12, 2025

(54) ELECTROMECHANICAL JOINING MODULE

(71) Applicant: Kistler Holding AG, Winterthur (CH)

(72) Inventors: Jochen SCHNEIDER, Schorndorf (DE); Stanko TEPSIC, Schorndorf (DE)

(21) Appl. No.: 18/975,303

(22) Filed: Dec. 10, 2024

(30) Foreign Application Priority Data
Dec. 11, 2023 (EP) 23215592.9

(51) Int. Cl. H02K 3/28; H02K 11/21; H02K 41/02

(52) U.S. Cl. CPC H02K 3/28; H02K 11/21; H02K 41/02

(57) ABSTRACT

An electromechanical joining module for applying a force includes a drive unit attached to a tappet moveable by the drive unit in a linear manner. A force transducer is attached to the tappet and measures the applied force and generates measured values for the measured force. The tappet and force transducer can be moved linearly relative to a stationary stator over a stroke length. The tappet includes tappet electronics and a tappet coil. The stator includes stator electronics and a stator coil, which remains in a close arrangement with respect to the tappet coil in the course of linear movement over a stroke length. The tappet electronics and the stator electronics are configured for transmitting the measured values as measured data from the tappet coil to the stator coil by near-field telemetry as the stator coil extends over the entire stroke length.

### FIELD OF THE INVENTION

The invention relates to an electromechanical joining module for applying a force and including a drive unit, which is connected to drive a tappet in a linear manner, tappet electronics, a tappet coil, a force transducer, which is attached to the tappet and measures the applied force, a stationary stator, stator electronics and a stator coil the tappet coil to the stator coil by near-field telemetry

### BACKGROUND OF THE INVENTION

Electromechanical joining modules are used in industrial production for a variety of assembly and joining processes such as stamping, punching, riveting, clinching, etc. An electromechanical joining module comprises an electric motor, a screw drive, a tappet and a force transducer. The electric motor is operatively connected to the screw drive and a rotary movement of the electric drive is converted into a linear movement by the screw drive. Said tappet and the force transducer are attached to the screw drive and are moved with the linear movement. They are moved in a linear manner over a stroke length of several 100 mm. For efficient production, the electromechanical joining module exhibits a high movement speed of about 400 mm/s, a high stroke rate of over 10 strokes/min and a high repeat accuracy of 0.01 mm. The force transducer measures the force applied by the tappet over several orders of magnitude. It generates measured data for the measured force. The measured data exhibit a measurement accuracy of 0.5%.

Such an electromechanical joining module is known from WO2011009223A1, which corresponds to applicant's United States Patent Application Publication No. 2012-0090168 that is hereby incorporated herein in its entirety for all purposes. The electric motor and the screw drive form a drive unit. The drive unit comprises a stator. The stator is stationary. The tappet can be moved in a linear manner relative to the stator. The tappet comprises a tappet end facing away from the drive unit. The force transducer is attached to the tappet end.

According to the teaching of document WO2011009223A1, which corresponds to applicant's commonly owned US Patent Application Publication No. 2012-0090168, which is hereby incorporated herein in its entirety for all purposes, said tappet comprises tappet electronics and a tappet coil for this purpose. The tappet coil extends over the entire stroke length. It comprises a single winding and is located in a groove in the tappet. The stator comprises stator electronics and a stator coil. Said stator coil is U-shaped and remains in a close arrangement with respect to the tappet coil in the course of linear movement. The tappet electronics and the stator electronics are suitable for transmitting the measured data from the tappet coil to the stator coil via near-field telemetry. This involves an inductive coupling between the tappet coil and the stator coil.

### OBJECTS AND SUMMARY OF THE INVENTION

The object of the present invention is to improve the transmission of measured data known from the document WO2011009223A1 in terms of availability, simplifying its design and realizing it cost-effectively.

This object is solved by the features described herein.

The invention relates to an electromechanical joining module for applying a force; comprising a drive unit and a tappet, which tappet is attached to the drive unit and can be moved by the drive unit in a linear manner; comprising a force transducer, which is attached to the tappet and measures the applied force and generates measured values for the measured force, comprising a stator, which is stationary, which tappet and which force transducer can be moved in a linear manner relative to the stator over a stroke length, which tappet comprises tappet electronics and a tappet coil; which stator comprises a stator electronics and a stator coil; which tappet coil remains in a close arrangement with respect to the stator coil in the course of linear movement; which tappet electronics and which stator electronics are suitable for transmitting the measured values as measured data from the tappet coil to the stator coil by near-field telemetry; wherein the stator coil extends over the entire stroke length.

In contrast to the electromechanical joining module of the document WO2011009223A1, said stator coil in the electromechanical joining module according to the invention extends over the entire stroke length.

This has several advantages, and a sampling is now described. Because the tappet does not need to provide space for a tappet coil extending over the entire stroke length, said tappet gains mechanical stability. The groove is omitted. The gain in mechanical stability reduces the bending of the tappet when the force is applied. This in turn reduces the probability that the stator coil and the tappet coil, which are in a close arrangement with respect to each other, can come into contact as a result of bending of the tappet. Any such contact would interrupt the transmission of the measured data and impairs the availability of the electromagnetic joining module. By omitting the groove in the tappet, a shielding of the inductive coupling in the course of near-field telemetry is prevented, which further improves the transmission of the measured data and thus the availability of the electromagnetic joining module. Furthermore, according to the teachings of the document WO2011009223A1, a guide surface must be manufactured with high precision also in the area of the tappet coil, which is a complex and expensive manufacturing process that is avoided by having the tappet guided in a plain bearing in the stator according to the present invention. Finally, on the stator radially surrounding the stator, comparatively more space is available for the arrangement of the stator coil, which extends over the entire stroke length. This enables a structurally simple and cost-effective arrangement of the stator coil on the stator.

Advantageous embodiments of the electromechanical joining module according to the invention are provided throughout the detailed description.

### BRIEF DESCRIPTION OF THE DRAWINGS

In the following, the invention is explained in more detail with reference to a presently preferred embodiment with the aid of the following figures.

FIG. 1 shows a perspective view of a part of an electromechanical joining module 1 and includes three enlarged views of each of three portions of the main perspective figure; and

FIG. 2 shows a schematic representation of a part of a tappet 30 comprising a tappet coil 32 and a stator 20 with a stator coil 22 and a transformer coil 25 of the electromechanical joining module 1 according to FIG. 1.

Identical reference numerals in the figures denote identical objects.

### DETAILED DESCRIPTION OF EXEMPLARY EMBODIMENTS OF THE INVENTION

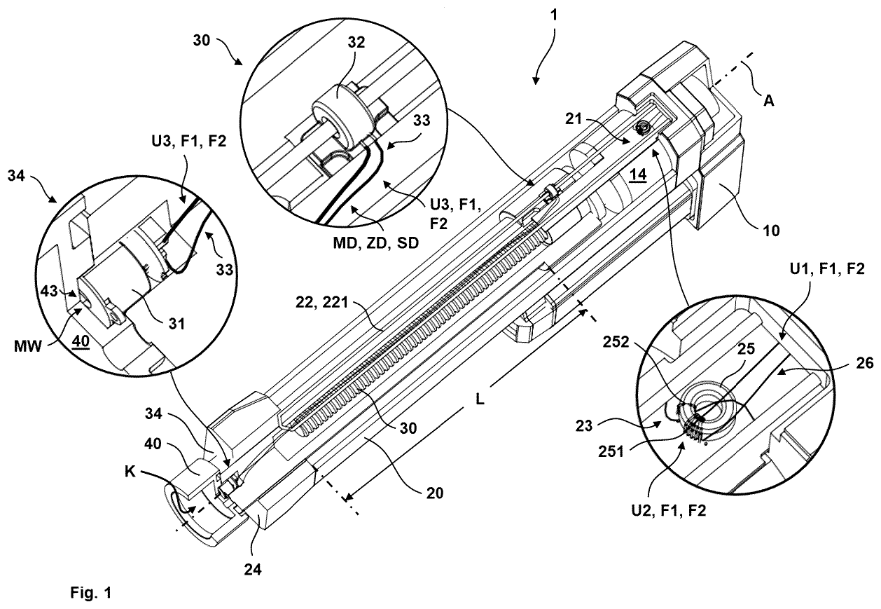

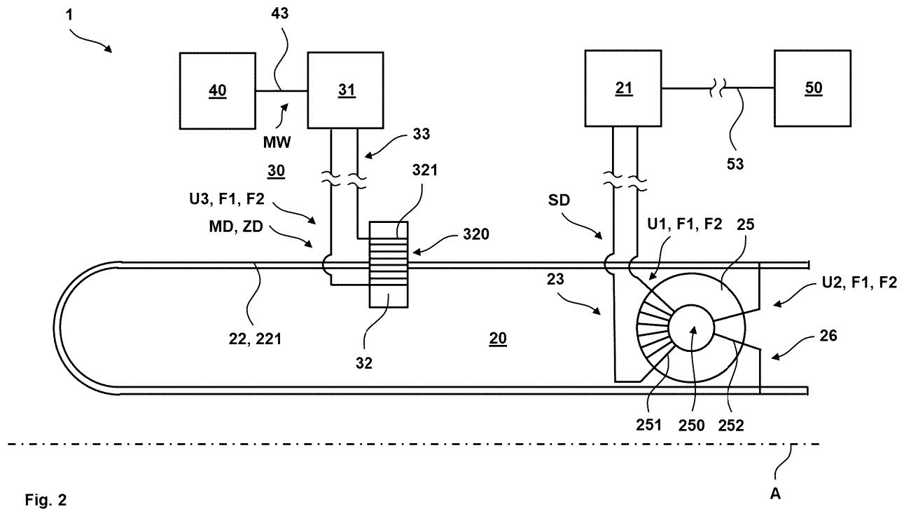

FIG. 1 shows a view of a part of an electromechanical joining module 1. As schematically depicted in FIG. 1, the electromechanical joining module 1 comprises a drive unit 10, a stator 20, a tappet 30 and a force transducer 40. Details in this respect can be seen in a left, a middle and a right enlarged section of FIG. 1. The electromechanical joining module 1 also comprises an evaluation unit 50, which can be seen in the schematic diagram in FIG. 2.

The drive unit 10 is configured in any conventional manner to perform the function of applying a force K via said tappet 30. Said force K can be applied to a joining body not shown in the figures. Said drive unit 10 can comprise an electric motor, a screw drive, a brake and a control unit. The electric motor and the screw drive are operatively connected, and a rotary output movement of the electric motor is converted into a linear movement by said screw drive. The linear movement takes place along a longitudinal axis A of the electromechanical joining module 1. The force K is applied by the linear movement. The linear movement can apply a very small force K of a few mN but also a very large force of several 100 kN. The linear movement is controlled by the control unit. The brake can slow down the linear movement. The linear movement speed of around 400 mm/s is achieved with a repeat accuracy of 0.01 mm. Said drive unit 10 comprises a drive unit end 14 on the longitudinal axis A.

The stator 20 is configured in any conventional manner to perform a housing function and radially surrounds the tappet 30 at least partially and thus protects the tappet 30 from harmful environmental impacts such as contamination (dust, moisture, etc.). Said stator 20 is stationary. The term “stationary” means that the stator 20 retains its position when said tappet 30 is moved. Thus, the tappet 30 is moved in a linear manner relative to the stator 20. Said stator 20 comprises a stator end 24 facing away from the drive unit 10.

Said tappet 30 is attached to the drive unit end 14 and is moved with the linear movement. The tappet 30 can be moved in a linear manner over a stroke length L of several 100 mm. The stroke length L extends along the longitudinal axis A of the electromechanical joining module 1. As schematically depicted in the exemplary embodiment of FIG. 1, the stroke length L extends from the drive unit end 14 to the stator end 24.

Said tappet 30 comprises a tappet end 34 facing away from the drive unit 10. Details of the tappet end 34 can be seen in the left-hand enlarged section of FIG. 1. The tappet 30 applies the force K via the tappet end 34. The force transducer 40 is attached to the tappet end 34.

The force transducer 40 is configured in any conventional manner to perform the function of measuring the force K applied by said tappet 30. The force transducer 40 desirably can be provided as a strain gauge or a piezoelectric sensor. The force transducer 40 is not limited to measuring a force K. It desirably can also be configured to measure a momentum applied by the tappet 30, such as a bending moment, a torque, etc. It desirably can be configured to measure the force K over several orders of magnitude. Said force transducer 40 desirably is configured to include a tool holder that is configured for attaching a tool not shown in the figures. The force transducer 40 is configured and connected in such a manner as to be moved together with the tappet 30.

As schematically depicted in one of the enlarged views of FIG. 1, the tappet 30 comprises a tappet electronics 31. Said tappet electronics 31 desirably can be arranged at the tappet end 34. The force transducer 40 is electrically connected to the tappet electronics 31 via at least one force transducer line 43. Said force transducer line 43 consists of electrically conductive material such as copper, etc. The exemplary embodiment of FIG. 1 has several wire-shaped force transducer lines 43. Said force transducer 40 generates measured values MW for the measured force K. The measured values MW are analog signals such as electrical voltages in the strain gauge or electrical charges in the piezo-electric sensor. The force transducer 40 is configured to transmit the measured values MW to the tappet electronics 31 via the force transducer cable 43. Said tappet electronics 31 is configured for converting the measured values MW from their electrically analog form into measured data MD of an electrical digital form. When converting the measured values MW into measured data MD, the tappet electronics 31 electrically amplifies the measured values MW and digitizes them. To that end, the tappet electronics 31 amplifies the measured values MW in a measuring range. For the electrical amplification, the tappet electronics 31 sets one of several possible measuring ranges or changes a set measuring range, respectively. The measured data MD are digital data. The measured data MD exhibit a measurement accuracy of less than or equal to 0.5%.

The measured data MD are evaluated in the evaluation unit 50. The evaluation unit 50 desirably can be arranged remotely from the electromechanical joining module 1. In the schematic illustration according to FIG. 2, said evaluation unit 50 is electrically connected to the stator electronics 21 via an evaluation unit line 53. For the evaluation, the measured data MD are first transmitted from the tappet electronics 31 to the stator electronics 21 and from the stator electronics 21 to the evaluation unit 50. The measured data MD desirably are transmitted from the tappet 30 to the stator 20 by means of conventional near-field telemetry, which is a method known from the ISO/IEC 14443 or ISO/IEC 15693 series of standards for the contactless transmission of digital data by electromagnetic induction using coils.

In the following explanation, the inductive coupling of the coils of the tappet 30 and the stator 20 is described in detail.

The stator 20 comprises a stator electronics 21, a stator coil 22 and at least one stator line 23, 26. The stator line 23, 26 is made of electrically conductive material such as copper, etc. Preferably, as schematically shown in FIGS. 1 and 2, the stator line 23, 26 comprises a first stator line 23 and a second stator line 26. The exemplary embodiment of FIGS. 1 and 2 comprises a plurality of wire-shaped first stator lines 23 and a plurality of wire-shaped second stator lines 26.

The near-field telemetry is performed with at least one carrier frequency F1, F2. Preferably, the carrier frequency F1, F2 comprises a first carrier frequency F1 of 13.56 MHz and a second carrier frequency F2 in the range of 119 to 135 kHz. The tappet electronics 31 is suitable for generating the first carrier frequency F1. The stator electronics 21 is configured for generating the second carrier frequency F2.

Preferably, said stator 20 comprises a transformer coil 25. Details of the transformer coil 25 can be seen in the right-hand enlarged section of FIG. 1. Preferably, the stator electronics 21 is electrically connected to the transformer coil 25 via the first stator line 23.

The stator electronics 21 is configured for generating an electrical alternating voltage with the second carrier frequency F2. The electrical alternating voltage is applied to the transformer coil 25 via the first stator line 23. In the following explanation, the electrical alternating voltage is also referred to as the electrical primary voltage U1 of the stator electronics 21. The electrical primary voltage U1 desirably can be in the range from 10 to 20 V.

Preferably, the transformer coil 25 desirably shown schematically in FIGS. 1 and 2 desirably is a toroidal core coil with a toroidal core made of magnetic material such as iron, ferrite, etc. The toroidal core of the transformer coil 25 defines a central through-hole 250 shown schematically in FIG. 2. The central through-hole 250 of the transformer coil 25 extends perpendicular to the longitudinal axis A of the electromechanical joining module 1. The transformer coil 25 comprises transformer coil windings 251, 252. The transformer coil windings 251, 252 are made of electrically conductive material such as copper, etc. Preferably, the transformer coil windings 251, 252 comprise first transformer coil windings 251 and second transformer coil windings 252. The number of first transformer coil windings 251 can be in the range from five to ten. The number of second transformer coil windings 252 can be in the range from one to five. Preferably, as shown schematically in FIG. 2, the number of second transformer coil windings 252 is equal to one. The first transformer coil windings 251 are electrically connected to the first stator line 23. Each of the second transformer coil windings 252 is electrically connected to the second stator line 26.

The transformer coil 25 is configured to perform the function of a transformer. The transformer coil 25 is suitable for transforming the electrical primary voltage U1 into an electrical secondary voltage U2 via the ratio of the number of first transformer coil windings 251 to the number of second transformer coil windings 252. The electrical secondary voltage U2 desirably can be in the range from 1 to 2 V. The electrical secondary voltage U2 exhibits the second carrier frequency F2 of the electrical primary voltage U1.

Said stator coil 22 and the transformer coil 25 are in a close arrangement with respect to each other. The close arrangement of the stator coil 22 and the transformer coil 25 is between a few millimeters and a few centimeters.

Said stator coil 22 is made of electrically conductive material such as aluminum, brass, steel, etc. The stator coil 22 is attached to the stator 20 in an electrically insulated manner. Preferably, the stator coil 22 comprises a single stator coil winding 221. Preferably, the stator coil 22 has the shape of a “U” like a horseshoe, with two long sides and one relatively shorter side contiguously disposed between the two relatively longer sides. Each of the two relatively longer sides extends parallel to the longitudinal axis A of the electromechanical joining module 1.

The transformer coil 25 and the stator coil 22 are electrically connected via the second stator line 26. Thus, the electrical secondary voltage U2 is applied to the stator coil 22.

The electrical secondary voltage U2 generates an electrical alternating current in the stator coil 22. The electrical alternating current generates a magnetic field. The field lines of the magnetic field proceed in a circle around the stator coil winding 221

Said tappet 30 comprises a tappet coil 32. The tappet coil 32 is configured and disposed to remain in a close arrangement with respect to the stator coil 22 in the course of linear movement of the tappet 30 with respect to the stator 20. The distance between the close arrangement of tappet coil 32 and stator coil 22 is a few millimeters (mm) to a few centimeters (cm).

Details of the tappet coil 32 can be seen in the central enlarged section of FIG. 1. Preferably, the tappet coil 32 is also a toroidal core coil with a toroidal core made of magnetic material such as iron, ferrite, etc. The toroidal core of said tappet coil 32 defines a central through-hole 320, which is schematically shown in FIG. 2. The central through-hole 320 of the tappet coil 32 extends parallel to the longitudinal axis A of the electromechanical joining module 1. The tappet coil 32 comprises a plurality of tappet coil windings 321. The tappet coil windings 321 consist of electrically conductive material such as copper, etc. The number of tappet coil windings 321 can be in the range from five to ten. Preferably, the number of first transformer coil windings 251 is equal to the number of tappet coil windings 321.

Said stator coil 22 and tappet coil 32 are configured to perform the function of establishing an inductive coupling with one another. For this purpose, said stator coil 22 and tappet coil 32 are arranged with respect to each other in such a way that the tappet coil 32 completely surrounds the winding 221 of the stator coil 22 in a plane perpendicular to the longitudinal axis A in certain regions. In the exemplary embodiment according to FIGS. 1 and 2, the stator coil winding 221 projects through the central through-hole 320 of said tappet coil 32.

In a toroidal core coil, the field lines of a magnetic field proceed in a circle inside the toroidal core coil. Thus, the field lines of the magnetic field of said stator coil 22 exactly proceed at locations where the field lines of a magnetic field of the tappet coil 32 continue, which results in an optimal inductive coupling.

Thus, said stator coil 22 and tappet coil 32 are configured for inducing an electrical alternating voltage U3 with the second carrier frequency F2 of the electrical secondary voltage U2 in the tappet coil 32 with the electrical secondary voltage U2 of the stator coil 22.

Said stator coil 22 and tappet coil 32 also are configured to perform the function of a transformer. Said stator coil 22 and tappet coil 32 are configured for transforming the electrical secondary voltage U2 of the stator coil 22 into an electrical alternating voltage U3 in the tappet coil 32. The ratio of the number of stator coil windings 221 to the number of tappet coil windings 321 transforms the electrical secondary voltage U2 of the stator coil 22 into the electrical alternating voltage U3 of the tappet coil 32. With the same number of first transformer coil windings 251 and tappet coil windings 321, the electrical alternating voltage U3 of the tappet coil 32 is largely equal to the electrical primary voltage U1 of the transformer coil 25.

The tappet coil 32 is electrically connected to the tappet electronics 31 via at least one tappet line 33. Said tappet line 33 is made of electrically conductive material such as copper, etc. The tappet line 33 is electrically connected to the tappet windings 321 of the tappet coil 32. The tappet electronics 31 is configured for generating the first carrier frequency F1. The measured data MD are introduced into the electrical alternating voltage U3 of the tappet coil 32 by modulating the first carrier frequency F1. Various conventional modulation methods, such as phase modulation, frequency modulation, etc., may be employed herein. Preferably, phase modulation is used. Said tappet electronics 31 is configured for introducing the measured data MD into the electrical primary voltage U1 by phase modulation of the first carrier frequency F1 of the electrical alternating voltage U3 of the tappet coil 32. The first carrier frequency F1 is then introduced into the electrical secondary voltage U2 by transformation of the electrical alternating voltage U3, and the first carrier frequency F1 is introduced into the electrical primary voltage U1 by transformation of the electrical secondary voltage U2. And the stator electronics 21 is configured for demodulating the phase-modulated first carrier frequency F1 of the electrical primary voltage U1 and thus extracting the measured data MD from the electrical primary voltage U1. For evaluation purposes, the measured data MD are transmitted from the stator electronics 21 to the evaluation unit 50.

The inductive coupling between the stator coil 22 and the tappet coil 32 is also used to transmit additional data ZD from the tappet electronics 31 to the stator electronics 21. Additional data ZD are at least one of the following kinds of information with respect to the tappet electronics 31 and the force transducer 40: a specification of the sensitivity of the force transducer 40, or a specification with respect to the measuring range of the tappet electronics 31, in which measuring range the tappet electronics 31 amplifies the measured values MW in the course of conversion. The tappet electronics 31 is configured for introducing the additional data ZD into the electrical primary voltage U1 by phase modulation of the first carrier frequency F1 of the electrical alternating voltage U3 of the tappet coil 32. The stator electronics 21 is configured for demodulating the phase-modulated first carrier frequency F1 of the electrical primary voltage U1 and thus extracting the additional data ZD from the electrical primary voltage U1. For evaluation purposes, the additional data ZD are transmitted from the stator electronics 21 to the evaluation unit 50.

The inductive coupling between said stator coil 22 and tappet coil 32 is also used to transmit electrical energy from the stator electronics 21 to the tappet electronics 31. For this purpose, the tappet electronics 31 is configured for taking the electrical alternating voltage U3 from the tappet coil 32 and using it to supply power to the tappet electronics 31 or the force transducer 40, respectively.

The inductive coupling between said stator coil 22 and tappet coil 32 is also used to transmit control data SD from the stator electronics 21 to the tappet electronics 31. The control data SD are digital data. The control data SD can be used to control the operation of said tappet electronics 31. In this way, the tappet electronics 31 can be switched on and off by means of the control data SD. Additionally, the tappet electronics 31 can use the control data SD to set or change, respectively, a measuring range, in which measuring range the tappet electronics 31 amplifies the measured values MW in the course of conversion. For this purpose, the stator electronics 21 is configured for introducing control data SD by phase modulation of the second carrier frequency F2 of the electrical primary voltage U1 into the electrical alternating voltage U3 of the tappet coil 32. The tappet electronics 31 is configured for demodulating the phase-modulated second carrier frequency F2 of the electrical alternating voltage U3 of the tappet coil 32 and thus extracting the control data SD from the electrical alternating voltage U3 of the tappet coil 32 and using the control data SD to operate said tappet electronics 31.

### LIST OF REFERENCE NUMERALS

1 electromechanical joining module
10 Drive unit
14 Drive unit end
20 Stator
21 Stator electronics
22 Stator coil
221 Stator coil winding
23 first stator line
24 Stator end
25 Transformer coil
250 central through-hole of the transformer coil
251 first transformer coil windings
252 second transformer coil windings
26 second stator line
30 Tappet
31 Tappet electronics
32 Tappet coil
33 Tappet line
34 Tappet end
320 central through-hole of the tappet coil
321 Tappet coil windings
40 Force transducer
43 Force transducer line
50 Evaluation unit
53 Evaluation unit line
A Longitudinal axis
F1 first carrier frequency
F2 second carrier frequency
K Force
L Stroke length
MD Measured data
MW Measured values
SD Control data
U1 electrical primary voltage
U2 electrical secondary voltage
U3 electrical alternating voltage
ZD Additional data

What is claimed is:

1. Electromechanical joining module for applying a force, comprising:
a drive unit;
a tappet attached to the drive unit so as to be moveable by the drive unit in a linear manner, wherein the tappet includes a tappet coil and tappet electronics connected to the tappet coil;
a force transducer attached to the tappet and configured to measure the applied force and generate measured values for the measured force;
a stator, which includes a stator coil and stator electronics connected to the stator coil and wherein the stator is disposed so that the tappet and the force transducer can be moved in a linear movement relative to the stator over a stroke length while the tappet coil remains in a close arrangement with respect to the stator coil in the course of the linear movement;
wherein the tappet electronics and the stator electronics are configured for transmitting the measured values as measured data from the tappet coil to the stator coil by near-field telemetry;
wherein the stator coil is configured and disposed to extend over the entire stroke length.

2. Electromechanical joining module according to claim 1, wherein said stator coil comprises a single stator coil winding.

3. Electromechanical joining module according to claim 2, wherein said tappet coil completely surrounds the stator coil winding in a plane perpendicular to the stroke length in certain regions.

4. Electromechanical joining module according to claim 2, wherein said tappet coil is a toroidal core coil, which toroidal core coil defines a central through-hole 320; and wherein the stator coil winding projects through the central through-hole of the tappet coil.

5. Electromechanical joining module according to claim 2, wherein said stator comprises a transformer coil; wherein the stator electronics is configured for generating an electrical primary voltage that is applied to the transformer coil; and wherein the transformer coil is configured for transforming the electrical primary voltage into an electrical secondary voltage.

6. Electromechanical joining module according to claim 5, wherein said transformer coil is a toroidal core coil that includes a number of first transformer coil windings and a number of second transformer coil windings; and wherein the ratio of the number of first transformer coil windings to the number of second transformer coil windings transforms the electrical primary voltage into the electrical secondary voltage.

7. Electromechanical joining module according to claim 2, wherein said stator electronics is configured for generating an electrical primary voltage from an electrical secondary voltage present at the stator coil; and wherein said stator coil and tappet coil are configured for inducing an electrical alternating voltage in the tappet coil with the electrical secondary voltage of the stator coil.

8. Electromechanical joining module according to claim 7, wherein said stator coil and tappet coil are configured for transforming the electrical secondary voltage into an electrical alternating voltage.

9. Electromechanical joining module according to claim 8, wherein said tappet coil comprises a plurality of tappet coil windings; and wherein the ratio of the number of stator coil windings to the number of tappet coil windings transforms the electrical secondary voltage of the stator coil into the electrical alternating voltage of the tappet coil.

10. Electromechanical joining module according to claim 7, wherein said electrical alternating voltage of the tappet coil comprises a first carrier frequency; wherein the force transducer is electrically connected to the tappet electronics via a force transducer line and configured to transmit the measured values to the tappet electronics via the force transducer line; wherein the tappet electronics is configured for converting the measured values into measured data and for introducing the measured data into the electrical primary voltage by modulating the first carrier frequency of the electrical alternating voltage of the tappet coil; and wherein the stator electronics is configured for demodulating the modulated first carrier frequency of the electrical primary voltage and thus for extracting the measured data from the electrical primary voltage.

11. Electromechanical joining module according to claim 10, wherein said tappet electronics is configured for introducing additional data into the electrical primary voltage by modulating the first carrier frequency of the electrical alternating voltage of the tappet coil; and wherein the stator electronics is configured for demodulating the modulated first carrier frequency of the electrical primary voltage and thus extracting the additional data from the electrical primary voltage.

12. Electromechanical joining module according to claim 11, wherein said additional data are at least one of the following information about the stator electronics and the force transducer: a specification of the sensitivity of the force transducer, or a specification with respect to the measuring range of the stator electronics, in which measuring range the stator electronics is configured to amplify the measured values in the course of conversion.

13. Electromechanical joining module according to claim 1, wherein said stator electronics is configured for inducing an electrical alternating voltage in the tappet coil via the stator coil; and wherein the tappet electronics is configured for extracting the electrical alternating voltage from the tappet coil and using the electrical alternating voltage to supply power to the tappet electronics or the force transducer, respectively.

14. Electromechanical joining module according to claim 13, wherein said electrical primary voltage and the electrical alternating voltage of the tappet coil comprise a second carrier frequency; wherein the stator electronics is configured for introducing control data into the electrical alternating voltage of the tappet coil by modulating the second carrier frequency of the electrical primary voltage; and wherein the tappet electronics is configured for demodulating the modulated second carrier frequency of the electrical alternating voltage of the tappet coil and thus extracting the control data from the electrical alternating voltage of the tappet coil and using the control data to operate the tappet electronics.

15. Electromechanical joining module according to claim 14, wherein said tappet electronics can be switched on and off by means of the control data or wherein the tappet electronics sets or changes, respectively, a measuring range with the control data, in which measuring range the tappet electronics is configured to amplify the measured values in the course of conversion.
